(19) United States
(12) Patent Application Publication
(10) Pub. No.: US 2020/0095775 A1
(43) Pub. Date: Mar. 26, 2020

(54) ANTIMICROBIAL TREATMENT FOR A HEALTHCARE FACILITY HEADWALL

(71) Applicant: Parasol Medical LLC, Buffalo Grove, IL (US)

(72) Inventor: Patrick E. Eddy, Allendale, MI (US)

(73) Assignee: Parasol Medical LLC, Buffalo Grove, IL (US)

(21) Appl. No.: 16/141,360

(22) Filed: Sep. 25, 2018

(51) Int. Cl. E04F 13/074; A01N 55/00

(52) U.S. Cl. CPC E04F 13/074; A01N 55/00

(57) ABSTRACT

A headwall for a healthcare facility comprising: one or more cover panels having an exterior surface; and an antimicrobial coating applied to the exterior surface of the one or more cover panels; wherein, the antimicrobial coating includes a silane quaternary ammonium ion or salt thereof. The headwall can further include one or more electrical outlets, one or more gas outlets, one or more accessory rails, a nurse call button, at least one end cap, at least one bed bumper, a bed locator, at least one lighting assembly, and a light switch, each having an exterior surface and an antimicrobial coating applied to the exterior surface. The silane quaternary ammonium ion or salt thereof can be one or more of: 3-(trimethoxysilyl)propyldimethyloctadecyl ammonium ion, 3-(trimethoxysilyl)propyldimethyloctadecyl ammonium chloride, 3-(trihydroxysilyl)propyldimethyloctadecyl ammonium ion, or 3-(trihydroxysilyl)propyldimethyloctadecyl ammonium chloride.

### BACKGROUND OF THE DISCLOSURE

A healthcare facility, such as a hospital, where a patient is treated by a healthcare provider sometimes utilizes a headwall in a room where the patient is being treated. The headwall consolidates and conceals electrical wiring, oxygen, and other medical gas tubing, data transmission cables, vacuum lines, among other things, into and behind a single headwall. The headwall, however, provides outlets for the wiring, tubing, cables, vacuum lines, etc. The headwall thus removes tripping hazards, reduces visual clutter, and increases the efficiency of patient treatment. However, the exterior surfaces of the headwall may contain harmful bacteria, microbes, viruses, and the like, which can subsequently be transferred to the patient undergoing treatment near the headwall.

### BRIEF SUMMARY OF THE DISCLOSURE

According to a first aspect of the present disclosure, a headwall for a healthcare facility comprises: one or more cover panels having an exterior surface; and an antimicrobial coating applied to the exterior surface of the one or more cover panels; wherein, the antimicrobial coating includes a silane quaternary ammonium ion or salt thereof.

Embodiments of the first aspect of the disclosure can include any one or a combination of the following features:
the headwall further comprises one or more electrical outlets having an exterior surface, and an antimicrobial coating applied to the exterior surface of the one or more electrical outlets, wherein, the antimicrobial coating includes a silane quaternary ammonium ion or salt thereof;
the headwall further comprises one or more gas outlets having an exterior surface, and an antimicrobial coating applied to the exterior surface of the one or more gas outlets, wherein, the antimicrobial coating includes a silane quaternary ammonium ion or salt thereof;
the headwall further comprises one or more accessory rails having an exterior surface, and an antimicrobial coating applied to the exterior surface of the one or more accessory rails, wherein, the antimicrobial coating includes a silane quaternary ammonium ion or salt thereof;
the headwall further comprises a nurse call button having an exterior surface, and an antimicrobial coating applied to the exterior surface of the nurse call button, wherein, the antimicrobial coating includes a silane quaternary ammonium ion or salt thereof;
the headwall is mounted to a finished wall of a healthcare facility and further comprises at least one end cap having an exterior surface, and an antimicrobial coating applied to the exterior surface of the end cap, wherein, the antimicrobial coating includes a silane quaternary ammonium ion or salt thereof;
the headwall further comprises at least one bed bumper having an exterior surface, and an antimicrobial coating applied to the exterior surface of the end cap, wherein, the antimicrobial coating includes a silane quaternary ammonium ion or salt thereof;
the headwall further comprises at least one lighting assembly having an exterior surface, and an antimicrobial coating applied to the exterior surface of the at least one lighting assembly, wherein, the antimicrobial coating includes a silane quaternary ammonium ion or salt thereof;
the headwall further comprises a bed locator having an exterior surface, and an antimicrobial coating applied to the exterior surface of the bed locator, wherein, the antimicrobial coating includes a silane quaternary ammonium ion or salt thereof; and
the silane quaternary ammonium ion or salt thereof is one or more of: 3-(trimethoxysilyl)propyldimethyloctadecyl ammonium ion, 3-(trimethoxysilyl)propyldimethyloctadecyl ammonium chloride, 3-(trihydroxysilyl)propyldimethyloctadecyl ammonium ion, or 3-(trihydroxysilyl)propyldimethyloctadecyl ammonium chloride.

According to a second aspect of the present disclosure, a method of imparting antimicrobial properties onto an exterior surface of a headwall for a healthcare facility comprises: applying, to an exterior surface of a headwall for a healthcare facility, a solution including a silane quaternary ammonium ion or salt thereof and isopropyl alcohol; wherein, the silane quaternary ammonium ion or salt thereof is one or more of: 3-(trimethoxysilyl)propyldimethyloctadecyl ammonium ion, 3-(trimethoxysilyl)propyldimethyloctadecyl ammonium chloride, 3-(trihydroxysilyl)propyldimethyloctadecyl ammonium ion, or 3-(trihydroxysilyl)propyldimethyloctadecyl ammonium chloride; wherein, the silane quaternary ammonium ion or salt thereof is between 0.1 percent and 10 percent by weight of the solution; and wherein, the isopropyl alcohol is between 30 percent to 90 percent by weight of the solution.

These and other features, advantages, and objects of the present disclosure will be further understood and appreciated by those skilled in the art by reference to the following specification, claims, and appended drawings.

### BRIEF DESCRIPTION OF THE DRAWINGS

FIG. 1 is a perspective view of a headwall in a healthcare facility, illustrating various components such as cover panels, gas outlets, vacuum outlets, electrical outlets, accessory rails, among others, each of which have an exterior surface;

FIG. 2 is a perspective view of another embodiment of a headwall attached to and jutting out from a finished wall, illustrating end caps having an exterior surface;

FIG. 3 is a side perspective view of an end cap of the headwall of FIG. 2, illustrating the exterior surface of the end cap;

FIG. 4 is a front view of another embodiment of a headwall, illustrating bed bumpers and other components, each having an exterior surface; and

FIG. 5 is a close up schematic view of Area V from FIG. 1, illustrating the exterior surface of one of the cover panels of the headwall of FIG. 1 and an antimicrobial coating applied to the exterior surface.

### DETAILED DESCRIPTION

For purposes of description herein, it is to be understood that the specific devices and processes illustrated in the attached drawings, and described in the following specification are simply exemplary embodiments of the inventive concepts defined in the appended claims. Hence, physical characteristics relating to the embodiments disclosed herein are not to be considered as limiting, unless the claims expressly state otherwise.

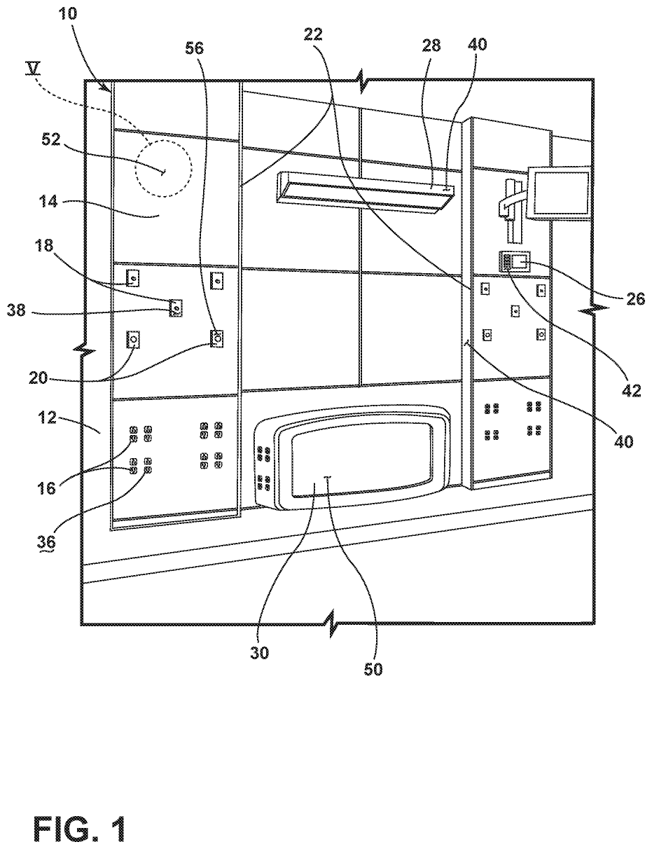

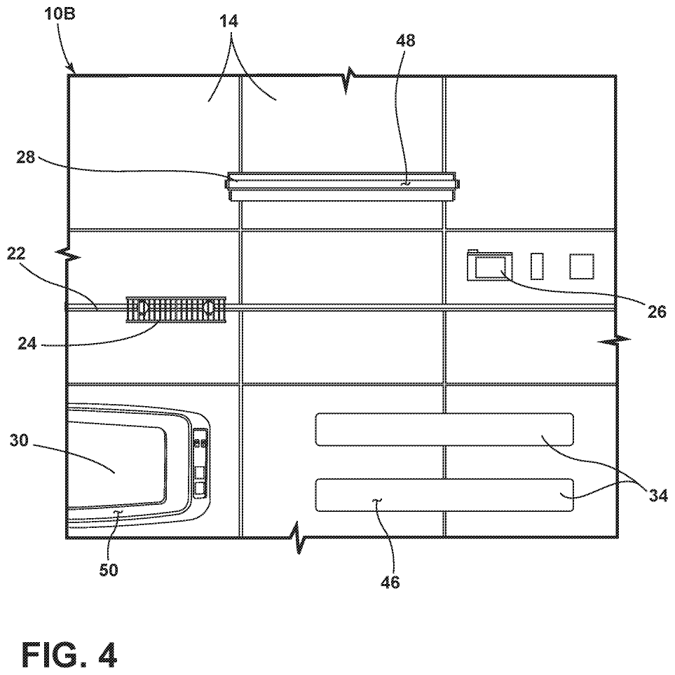

Referring to FIG. 1, a headwall 10 for a healthcare facility of the present disclosure is illustrated. The healthcare facility can be any facility where healthcare is provided to a patient. An example of a healthcare facility is a hospital. The headwall 10 of FIG. 1 is disposed on or adjacent to a wall 12 in a hospital. The headwall 10 includes one or more cover panels 14. The cover panel 14 covers the area behind the headwall 10 where cords, tubing, and the like are routed and where the structural support for the headwall 10 is placed. The headwall 10 includes electrical outlets 16, which provide an electrical connection for various healthcare devices. A cover panel 14 including several electrical outlets 16 can be referred to as a service panel. The headwall 10 includes gas outlets 18, which provide a connection point for devices that provide gases such as oxygen and hospital air to the patient. The headwall 10 includes gas vacuum outlets 20, which provide a connection point for devices that induce suction. The headwall 10 includes one or more accessory rails 22, which provide structural support for accessories such as baskets 24 (see FIG. 4), transfer poles, and IV poles. The accessory rails 22 can be vertical (as in FIG. 4), or horizontal (as in FIG. 4). The headwall 10 includes a nurse call button 26, which allows a person near the headwall 10 to request the attention of a nurse in the healthcare facility. The headwall 10 includes a lighting assembly 28, which illuminates the headwall 10 and environs. The headwall 10 includes a bed locator 30, which provides a structural cue where a bed for the patient should be located.

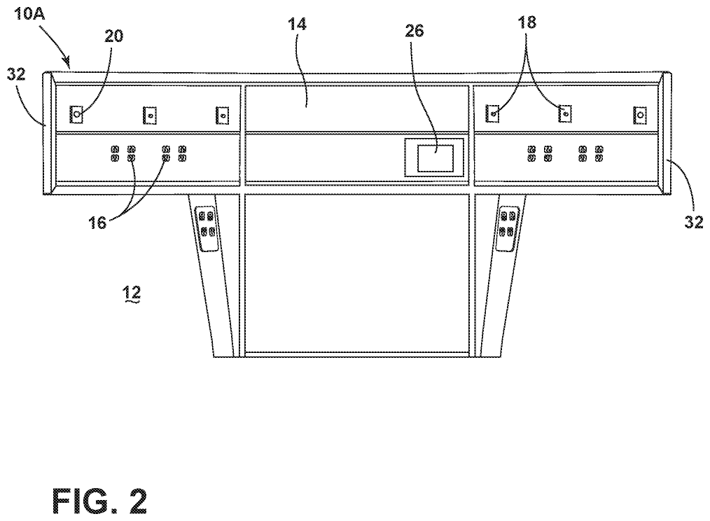

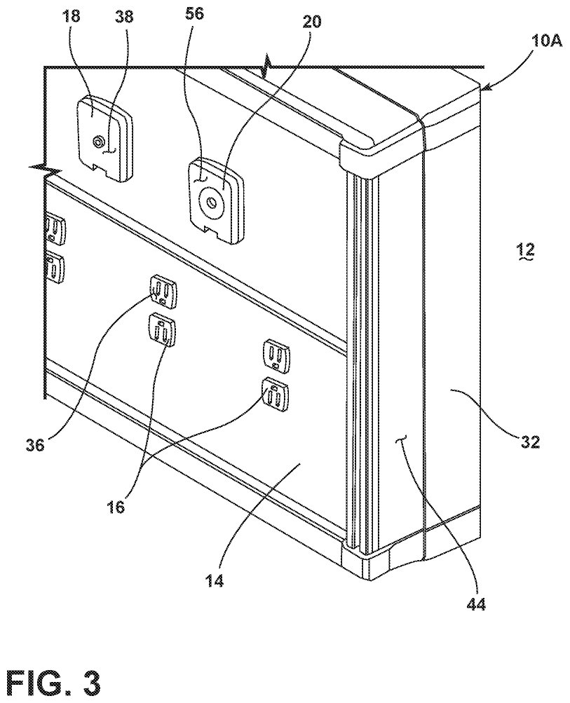

Referring now to FIGS. 2 and 3, another embodiment of a headwall 10A is illustrated. The headwall 10A is mounted to the wall 12, which is in a completed/finished state, of a healthcare facility, such that the cover panels 14 extend away from the wall 12. The headwall 10A includes several end caps 32, which close off the headwall 10A at the ends of the headwall 10A.

Referring now to FIG. 4, another embodiment of a headwall 10B is illustrated. In addition to the bed locator 30, the headwall 10B includes several bed bumpers 34. The bed bumpers 34 cushion a hospital bed pushed close to the headwall 10B. In this embodiment, the accessory rail 22 is supporting the basket 24.

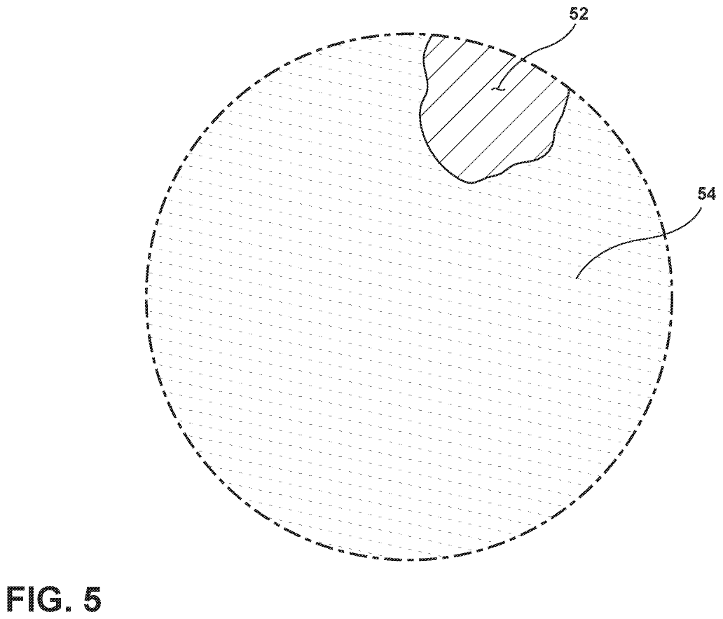

The headwalls 10, 10A, 10B and each of the components of the headwalls 10, 10A, 10B identified above have an exterior surface, respectively. In other words, the one or more electrical outlets 16 have an exterior surface 36, the one or more gas outlets 18 have an exterior surface 38, the one or more accessory rails 22 have an exterior surface 40, the nurse call button 26 has an exterior surface 42, the end caps 32 have an exterior surface 44, the at least one bed bumper 34 has an exterior surface 46, the at least one lighting assembly 28 has an exterior surface 48, the bed locator 30 has an exterior surface 50, the cover panels 14 have an exterior surface 52, and the one or more vacuum outlets 20 have an exterior surface 56. As illustrated in FIG. 5, an antimicrobial coating 54 is applied to the exterior surface 52 of the one or more cover panels 14. Although not separately illustrated, the antimicrobial coating 54 is additionally applied to the exterior surfaces 36, 38, 40, 42, 44, 46, 48, 50, 56 of the one or more electrical outlets 16, the one or more gas outlets 18, the one or more accessory rails 22, the nurse call button 26, the end caps 32, the at least one bed bumper 34, the at least one lighting assembly 28, the bed locator 30, and the one or more vacuum outlets 20, respectively. Any other component of the headwalls 10, 10A, 10B and the headwalls 10, 10A, 10B generally can have the antimicrobial coating 54 applied to the exterior surface thereof.

The antimicrobial coating 54 includes a silane quaternary ammonium ion or salt thereof. Preferred silane quaternary ammonium ions or salts thereof include 3-(trimethoxysilyl)propyldimethyloctadecyl ammonium ion, 3-(trimethoxysilyl)propyldimethyloctadecyl ammonium chloride, 3-(trihydroxysilyl)propyldimethyloctadecyl ammonium ion, or 3-(trihydroxysilyl)propyldimethyloctadecyl ammonium chloride. Applying the antimicrobial coating 54 to the various exterior surfaces 36, 38, 40, 42, 44, 46, 48, 50, 56 of the headwalls 10, 10A, 10B imparts antimicrobial properties on the various exterior surfaces 36, 38, 40, 42, 44, 46, 48, 50, 56, which prevent or lessen the ability of said exterior surfaces 36, 38, 40, 42, 44, 46, 48, 50, 56 to harbor harmful microbes, viruses, bacteria, and the like. Applying the antimicrobial coating 54 to the various exterior surfaces 36, 38, 40, 42, 44, 46, 48, 50, 56 serves to lessen the ability of the headwalls 10, 10A, 10B to act as vehicles that transmit the harmful microbes, viruses, bacteria, and the like to the patient.

Further described herein is a novel method of imparting antimicrobial properties onto any of the exterior surfaces 36, 38, 40, 42, 44, 46, 48, 50, 56 of the headwalls 10, 10A, 10B, described above, and to the exterior surfaces of the headwalls 10, 10A, 10B generally. The method comprises applying, to any of the exterior surfaces 36, 38, 40, 42, 44, 46, 48, 50, 56 of the headwalls 10, 10A, 10B, a solution including the silane quaternary ammonium ion or salt thereof, as described above. In addition to the silane quaternary ammonium ion or salt thereof, the solution can further include a solvent. A preferred solvent is isopropyl alcohol.

The silane quaternary ammonium ion or salt thereof can comprise between 0.1 percent and 10 percent by weight of the solution. More preferably, the silane quaternary ammonium ion or salt thereof can comprise between 0.75 percent and 5 percent by weight of the solution. Even more preferably, the silane quaternary ammonium ion or salt thereof can comprise between 1.9 percent and 2.1 percent by weight of the solution.

As for the isopropyl alcohol, the isopropyl alcohol can comprise between 30 percent to 90 percent by weight of the solution. More preferably, the isopropyl alcohol can comprise between 55 percent and 65 percent by weight of the solution. An example preferable solution comprises (by weight) 60.0 percent isopropyl alcohol, 2.02 percent 3-(trimethoxysilyl)propyldimethyloctadecyl ammonium chloride, and 34.19 percent deionized water.

Again, the solution can be applied to any exterior surface 36, 38, 40, 42, 44, 46, 48, 50, 56 of the headwalls 10, 10A, 10B, including but not limited to the exterior surface 52 of the one or more cover panels 14, the exterior surface 36 of the one or more electrical outlets 16, the exterior surface 38 of the one or more gas outlets 18, the exterior surface 40 of the one or more accessory rails 22, the exterior surface 42 of the nurse call button 26, the exterior surface 44 of the end caps 32, the exterior surface 46 of the at least one bed bumper 34, the exterior surface 48 of the at least one lighting assembly 28, the exterior surface 50 of the bed locator 30, the exterior surface 56 of the one or more vacuum outlets 20, and so on.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A headwall for a healthcare facility comprising:
one or more cover panels having an exterior surface; and
an antimicrobial coating applied to the exterior surface of the one or more cover panels;
wherein, the antimicrobial coating includes a silane quaternary ammonium ion or salt thereof.

2. The headwall of claim 1 further comprising:
one or more electrical outlets having an exterior surface; and
an antimicrobial coating applied to the exterior surface of the one or more electrical outlets;
wherein, the antimicrobial coating includes a silane quaternary ammonium ion or salt thereof.

3. The headwall of claim 1 further comprising:
one or more gas outlets having an exterior surface; and
an antimicrobial coating applied to the exterior surface of the one or more gas outlets;
wherein, the antimicrobial coating includes a silane quaternary ammonium ion or salt thereof.

4. The headwall of claim 1 further comprising:
one or more accessory rails having an exterior surface; and
an antimicrobial coating applied to the exterior surface of the one or more accessory rails;
wherein, the antimicrobial coating includes a silane quaternary ammonium ion or salt thereof.

5. The headwall of claim 1 further comprising:
a nurse call button having an exterior surface; and
an antimicrobial coating applied to the exterior surface of the nurse call button;
wherein, the antimicrobial coating includes a silane quaternary ammonium ion or salt thereof.

6. The headwall of claim 1 mounted to a finished wall of a healthcare facility further comprising:
at least one end cap having an exterior surface; and
an antimicrobial coating applied to the exterior surface of the end cap;
wherein, the antimicrobial coating includes a silane quaternary ammonium ion or salt thereof.

7. The headwall of claim 1 further comprising:
at least one bed bumper having an exterior surface; and
an antimicrobial coating applied to the exterior surface of bed bumper;
wherein, the antimicrobial coating includes a silane quaternary ammonium ion or salt thereof.

8. The headwall of claim 1 further comprising:
at least one lighting assembly having an exterior surface; and
an antimicrobial coating applied to the exterior surface of the at least one lighting assembly;
wherein, the antimicrobial coating includes a silane quaternary ammonium ion or salt thereof.

9. The headwall of claim 1 further comprising:
a bed locator having an exterior surface; and
an antimicrobial coating applied to the exterior surface of the bed locator;
wherein, the antimicrobial coating includes a silane quaternary ammonium ion or salt thereof.

10. The headwall of claim 1,
wherein, the silane quaternary ammonium ion or salt thereof is one or more of: 3-(trimethoxysilyl)propyldimethyloctadecyl ammonium ion, 3-(trimethoxysilyl)propyldimethyloctadecyl ammonium chloride, 3-(trihydroxysilyl)propyldimethyloctadecyl ammonium ion, or 3-(trihydroxysilyl)propyldimethyloctadecyl ammonium chloride.

11. A method of imparting antimicrobial properties onto an exterior surface of a headwall for a healthcare facility comprising:
applying, to an exterior surface of a headwall for a healthcare facility, a solution including a silane quaternary ammonium ion or salt thereof and isopropyl alcohol;
wherein, the silane quaternary ammonium ion or salt thereof is one or more of: 3-(trimethoxysilyl)propyldimethyloctadecyl ammonium ion, 3-(trimethoxysilyl)propyldimethyloctadecyl ammonium chloride, 3-(trihydroxysilyl)propyldimethyloctadecyl ammonium ion, or 3-(trihydroxysilyl)propyldimethyloctadecyl ammonium chloride;
wherein, the silane quaternary ammonium ion or salt thereof is between 0.1 percent and 10 percent by weight of the solution; and
wherein, the isopropyl alcohol is between 30 percent to 90 percent by weight of the solution.
